(19) United States
(12) Patent Application Publication
(10) Pub. No.: US 2013/0303016 A1
(43) Pub. Date: Nov. 14, 2013

(54) Joint Connector

(71) Applicant: Yazaki Corporation, Tokyo (JP)

(72) Inventor: Tomohiko Shimizu, Makinohara-shi (JP)

(73) Assignee: YAZAKI CORPORATION, Tokyo (JP)

(21) Appl. No.: 13/947,399

(22) Filed: Jul. 22, 2013

Related U.S. Application Data
(63) Continuation of application No. PCT/JP2012/054496, filed on Feb. 17, 2012.

(30) Foreign Application Priority Data
Feb. 18, 2011 (JP) 2011-033713

(51) Int. Cl. H01R 13/631

(52) U.S. Cl. CPC H01R 13/631
USPC 439/374

(57) ABSTRACT

In a joint connector, the electrical connecting parts are respectively provided with insertion guiding projections adapted to be inserted into and guided by guide grooves formed on the terminal containing rooms along a terminal inserting direction, and the terminal containing rooms are provided, on respective bottom walls thereof, with engaging grooves for restraining the insertion guiding projections from moving in a direction perpendicular to the terminal inserting direction.

### CROSS-REFERENCE TO RELATED APPLICATION

This application is a continuation of PCT application No. PCT/JP2012/0054496, which was filed on Feb. 17, 2012 based on Japanese Patent Application No. 2011-033713 filed on Feb. 18, 2011, the contents of which are incorporated herein by reference. Also, all the references cited herein are incorporated as a whole.

### BACKGROUND OF THE INVENTION

1. Field of the Invention

The present invention relates to a joint connector.

2. Description of the Related Art

As a conventional joint connector which is used for branch connection of a wire harness in an automobile, such a joint connector as disclosed in JP-A-08-250185, for example, has been known.

As shown in FIG. 9, a joint connector 100 includes a connector housing 111 which is provided with a plurality of terminal containing rooms 118 for containing terminal metal fittings 113 of a female type (female type terminal metal fittings), the terminal metal fittings 113 which are contained in the terminal containing rooms 118 in this connector housing 111, a cap 123 which can be fitted to an end of the connector housing 111 at a connecting end side of the terminal metal fittings 113, and joint terminals 129 which are provided on an inner face of this cap 123 so as to project toward the connector housing and adapted to interconnect the terminal metal fittings 113.

Specifically, the joint connector 100 of this type is so constructed that the cap 123 provided with the joint terminals 129 is fitted to the connector housing 111, for the purpose of preventing a thrust against the terminal metal fittings 113 which are contained in the terminal containing rooms 118, thereby to connect the joint terminals 129 with the terminal metal fittings 113 contained in the terminal containing rooms 118. Therefore, there is possibility in that the number of components is increased, and a whole shape becomes bulky, resulting in upsizing of the joint connector.

Under the circumstances, the joint connectors which are described in JP-A-H02-101474U and JP-A-H10-255936, for example, have been proposed.

Each of these joint connectors includes a connector housing, joint terminals which are inserted into one end part of the connector housing, and female type terminal metal fittings which are connected to these joint terminals.

In the joint connector of this type, the number of components can be reduced, because the housing is composed of only one component, and downsizing as a whole and cost reduction can be achieved.

However, the joint connectors which are described in the above mentioned JP-A-H02-101474U and JP-A-H10-255936 are so constructed that the joint terminals are locked and held by locking lances or locking projections inside the housing. Moreover, the female type terminal metal fittings to be engaged and connected with the joint terminals are also locked and held by locking lances in the housing, or simply connected by press fitting to the joint terminals.

As the results, backlashes of the female type terminal metal fittings in a state engaged with the joint terminals are likely to be increased, and hence, there is possibility in that contact stability between the female type terminal metal fittings and the joint terminals is decreased, and thrusts of the female type terminal metal fittings against tab pieces may occur.

### SUMMARY OF THE INVENTION

This invention has been made in view of the above described circumstances. It is an object of the present invention to provide a joint connector in which contact stability between female type terminal metal fittings and a joint terminal can be enhanced, and at the same time, thrusts of the female type terminal metal fittings against the joint terminal can be depressed.

In order to attain the above described object, the joint connector according to the present invention includes following features (1) to (4).

(1) A joint connector comprising

a plurality of female type terminal metal fittings

a joint terminal including a plurality of tab pieces which are adapted to be engaged and connected with the female type terminal metal fittings, and a connecting part for connecting the tab pieces for electrical continuity and

a connector housing formed of synthetic resin and including one end part of the housing which receives and hold the joint terminal having the tab pieces directed to the other end side of the housing, and the other end part of the housing provided with a plurality of terminal containing rooms in which electrical connecting parts of the female type terminal metal fittings and the tab pieces are brought into a mutually engaged state, by inserting the female type terminal metal fittings up to a prescribed position,

wherein the electrical connecting parts of the female type terminal metal fittings are respectively provided with insertion guiding projections to be guided by being inserted into guide parts which are formed on inner walls of the terminal containing rooms along a terminal inserting direction, and

the terminal containing rooms are provided, on their respective inner walls, with engaging grooves for restraining the insertion guiding projections of the electrical connecting parts which are engaged and connected with the tab pieces from moving in a direction perpendicular to the terminal inserting direction.

(2) in the joint connector having the structure as described in the above feature (1), the engaging grooves are defined by a plurality of comb-shaped projections which are formed in one parts of bottom walls of the terminal containing rooms so as to extend toward the other end side of the housing.

(3) In the joint connector having the structure as described in the above feature (2), taper faces for guiding the insertion guiding projections to be inserted into the engaging grooves are respectively formed at tip ends of the comb-shaped projections.

(4) The joint connector having any one of the structures as described in the above features (1) to (3), the electrical connecting parts of the female type terminal metal fittings are provided with guide projections respectively having inclined faces which are inclined forward and downward with respect to surfaces of the terminals, at a position dose to a distal end side of the terminals than a position where the insertion guiding projections are provided, and when the tip ends of the comb-shaped projections come into contact with the guide projections, distal end openings of the electrical connecting parts to be engaged and connected with the tab pieces are guided toward the tab pieces.

According to the joint connector having the structure as described in the above feature (1), because of the engaging grooves which are provided on the inner walls of the terminal containing rooms, it is possible to restrain the insertion guiding projections of the electrical connecting parts which are engaged and connected with the tab pieces of the joint terminal from moving in a direction perpendicular to the terminal inserting direction. As the results, backlashes of the electrical connecting parts with respect to the tab pieces in the engaged state can be eliminated, and contact stability between the female type terminal metal fittings and the joint terminal can be enhanced.

Specifically, besides the guide grooves for guiding the insertion guiding projections of the female type terminal metal fittings which have been inserted into the terminal containing rooms, the engaging grooves can eliminate backlashes of the electrical connecting parts in a state engaged and connected with the tab pieces. As the results, backlashes of the electrical connecting parts will not be restrained more than required, before the distal end openings of the electrical connecting parts are engaged with the tab pieces. In this manner, it is possible to depress thrusts of the female type terminal metal fittings against the tab pieces.

According to the joint connector having the structure as described in the above feature (2), because the engaging grooves are defined by a plurality of the comb-shaped projections which are formed in one parts of the bottom walls of the terminal containing rooms, it is possible to easily form the engaging grooves by integral molding, in the connector housing.

According to the joint connector having the structure as described in the above feature (3), because the taper faces are respectively formed at the tip ends of the comb-shaped projections, it is possible to smoothly guide the insertion guiding projections to be inserted into the engaging grooves.

According to the joint connector having the structure as described in the above feature (4), the tip ends of the comb-shaped projections come into contact with the guide projections which are provided at the distal end side of the electrical connecting parts, thereby to guide the distal end openings of the electrical connecting parts toward the tab pieces. As the results, it is possible to prevent the female type terminal metal fittings from thrusting against the tab pieces.

According to the present invention, it is possible to provide the joint connector in which the contact stability between the female type terminal metal fittings and the joint terminal can be enhanced, and at the same time, thrusts of the female type terminal metal fittings against the joint terminal can be restrained.

The present invention has been heretofore briefly described. Details of the present invention will be further clarified, by reading through “Description of Embodiments”), which will be described below, referring to the attached drawings.

### BRIEF DESCRIPTION OF THE DRAWINGS

FIG. 1 is an exploded perspective view of a joint connector according to an embodiment of the present invention.

FIG. 2 is a perspective view showing an outer appearance of a female type terminal metal fitting as shown in FIG. 1, as seen from a bottom face side.

FIG. 3 is a perspective view showing an outer appearance of a connector housing as shown in FIG. 1, as seen from a bottom face side.

FIG. 4 is a horizontal sectional view for explaining an operation when the female type terminal metal fitting is inserted into the connector housing as shown in FIG. 1.

FIG. 5 is a longitudinal sectional view showing a state where the female type terminal metal fitting is inserted halfway into the connector housing, for the purpose of explaining the operation when the female type terminal metal fitting is inserted into the connector housing as shown in FIG. 1.

FIG. 6 is a longitudinal sectional view showing a state where the female type terminal metal fitting has been completely inserted up to a prescribed position, for the purpose of explaining the operation when the female type terminal metal fitting is inserted into the connector housing of the joint connector as shown in FIG. 1.

FIG. 7 is an enlarged bottom view of a part for explaining the operation when the female type terminal metal fitting is inserted up to a position just short of the prescribed position in the connector housing as shown in FIG. 1.

FIG. 8 is an enlarged bottom view of a part for explaining the operation when the female type terminal metal fitting has been inserted up to the prescribed position in the connector housing as shown in FIG. 1.

FIG. 9 is a longitudinal sectional view of a conventional joint connector in a disassembled state.

### DESCRIPTION OF THE PREFERRED EMBODIMENTS

Now, the joint connector according to an embodiment of the present invention will be described in detail, referring to the attached drawings.

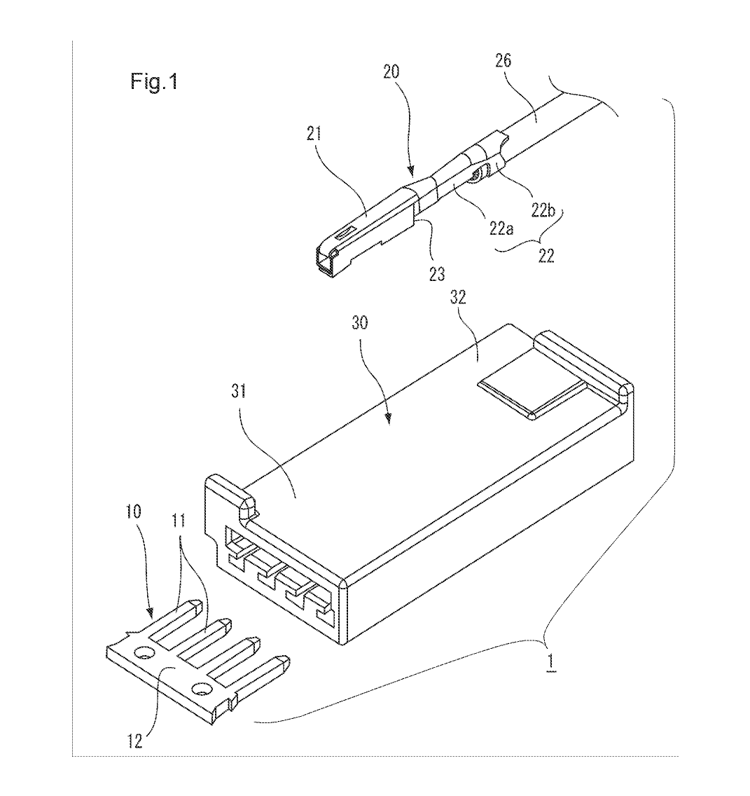

As shown in FIG. 1, a joint connector 1 in this embodiment includes a joint terminal 10, a plurality of female type terminal metal fittings 20, and a connector housing 30.

The joint terminal 10 is a product stamped out of a metal plate, and integrally molded including a plurality of (four in this embodiment) tab pieces 11 which are adapted to be engaged and connected with the female type terminal metal fittings 20, and a connecting part 12 for interconnecting these tab pieces 11 for electrical continuity.

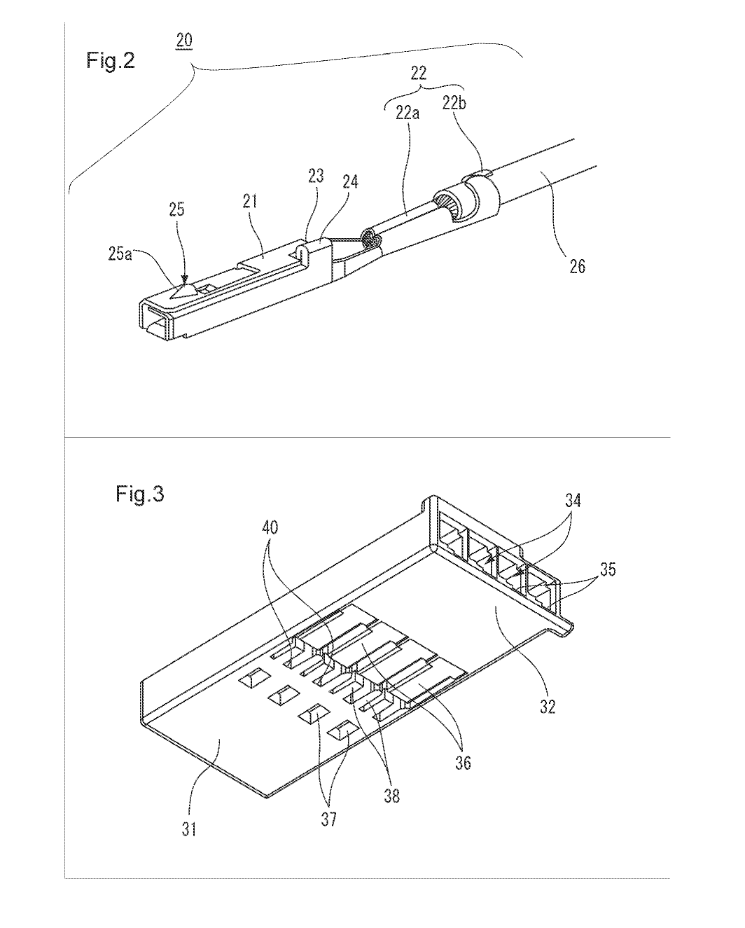

Each of the female type metal fittings 20 is a product stamped out of a metal plate, and includes, as shown in FIGS. 1 and 2, an electrical connecting part 21 in a columnar shape which is adapted to be engaged with the tab piece 11, an electric wire caulking part 22 which is extended from a back end of the electrical connecting part 21 and press fitted to an electric wire 26, a retaining lock part 23, an insertion guiding projection 24, and a guide projection 25.

The electric wire caulking part 22 is provided with a conductor caulking piece 22a which is press fitted to a conductor of the electric wire 26 for electrical continuity, and a covering caulking piece 22b which caulks a covering of the electric wire 26 thereby to secure the electric wire 26.

The retaining lock part 23 is a dented part which is formed at a back end side of the electrical connecting part 21, and locked to a locking lance 36 of the connector housing 30, which will be described below, thereby to prevent drop of the female type terminal metal fitting 20.

The insertion guiding projection 24 is projected from a bottom face of the electrical connecting part 21, in a side part at a backward end side thereof, and adapted to be inserted into a guide groove (guide part) 35 which is formed on an inner bottom face (inner wall) of a terminal containing room 34 of the connector housing 30, which will be described below, to be guided along a terminal inserting direction. This insertion guiding projection 24 is a is tongue-like piece which is formed by extending a part of a side wall of the electrical connecting part 21 and then, folding.

The guide projection 25 is projected from the bottom face of the electrical connecting part 21 at a distal end side of the female type terminal metal fitting 20 which is forward of a position where the insertion guiding projection 24 is provided, and formed with an inclined face 25a which is inclined forward and downward with respect to the bottom face of the electrical connecting part 21 (a surface of the terminal).

When this guide projection 25 comes into contact with a tip end of a comb-shaped projection 38 of the connector housing 30, which will be described below, a distal end opening of the electrical connecting part 21 to be engaged and connected with the tab piece 11 is guided toward the tab piece 11.

The connector housing 30 is a product of synthetic resin obtained by injection molding, and includes one end part 31 of the housing, and the other end part 32 of the housing which is the end part at an opposite side to the one end part 31.

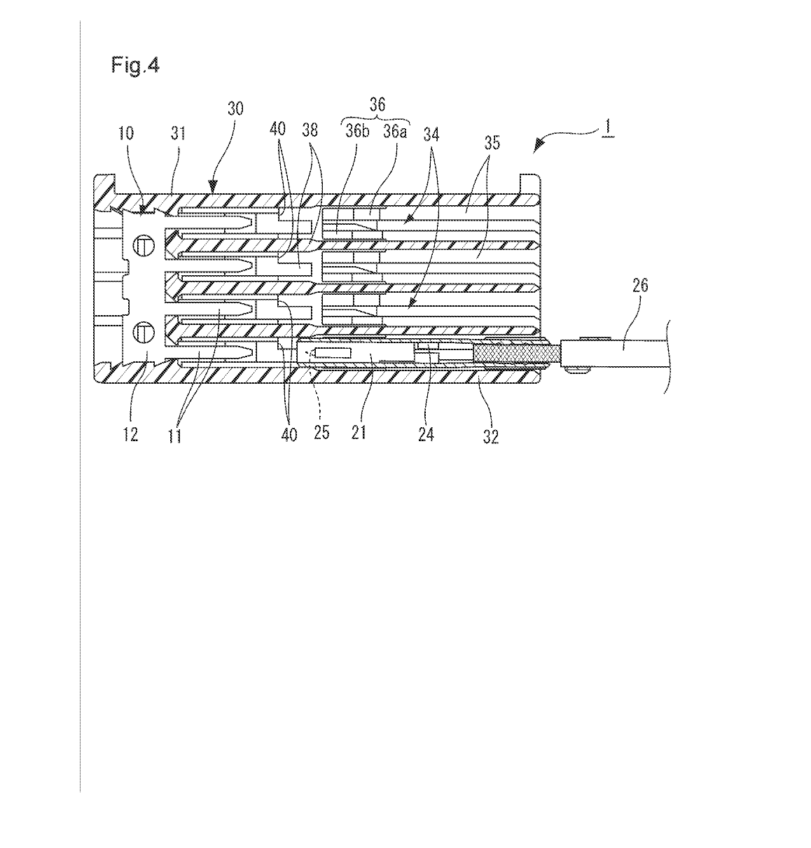

The one end part 31 of the housing receives and holds the joint terminal 10 having the tab pieces 11 directed to the other end part 32 of the housing, as shown in FIG. 4. In this embodiment, the joint terminal 10 is press fitted into the one end part 31 of the housing to be held therein.

As shown in FIGS. 3 and 4, a plurality of the terminal containing rooms 34 are provided in parallel in the other end part 32 of the housing. By inserting the female type terminal metal fittings 20 up to the prescribed position in these terminal containing rooms 34, the electrical connecting parts 21 of the female type terminal metal fittings 20 and the tab pieces 11 are brought into a mutually engaged state. Herein, the prescribed position means such a position that the tab pieces 11 and the electrical connecting parts 21 can obtain a necessary and sufficient contact length for electrical connection.

As shown in FIG. 4, each of the terminal containing rooms 34 is provided with the guide groove 35, on the inner bottom face thereof. When the female type terminal metal fitting 20 is inserted into the terminal containing room 34, this guide groove 35 slidably receives the insertion guiding projection 24 thereby to prevent defective insertion of the female type terminal metal fitting 20, and at the same time, guide the female type terminal metal fitting 20 up to the prescribed position.

Moreover, as shown in FIGS. 3 to 8, the locking lances 36, tab observing windows 37, and engaging grooves 40 are formed on the bottom walls of the terminal containing rooms 34, corresponding to the respective terminal containing rooms 34. As shown in FIGS. 4 to 6, each of the locking lances 36 has an elastic arm 36a which is extended toward the one end part 31 of the housing along the terminal containing room 34, and a terminal locking projection 36b which is provided on an inner face of a free end of the elastic arm 36a.

The terminal locking projection 36b projects inward of the terminal containing room 34, and adapted to be engaged with the retaining lock part 23 of the female type terminal metal fitting 20 which has been inserted up to the prescribed position, as shown in FIG. 6, thereby to prevent drop of the female type terminal metal fitting 20.

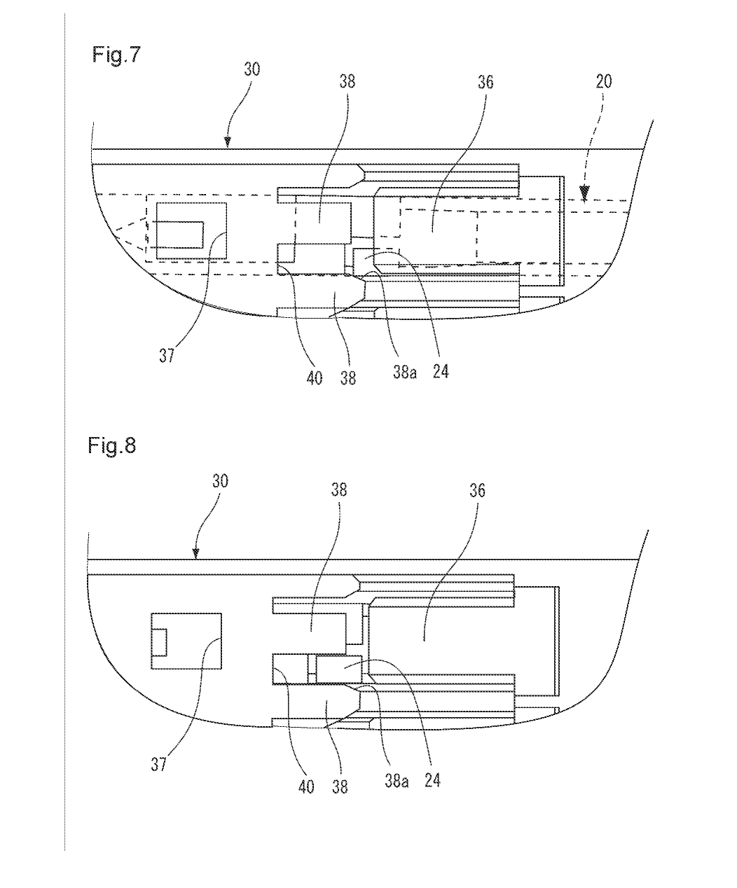

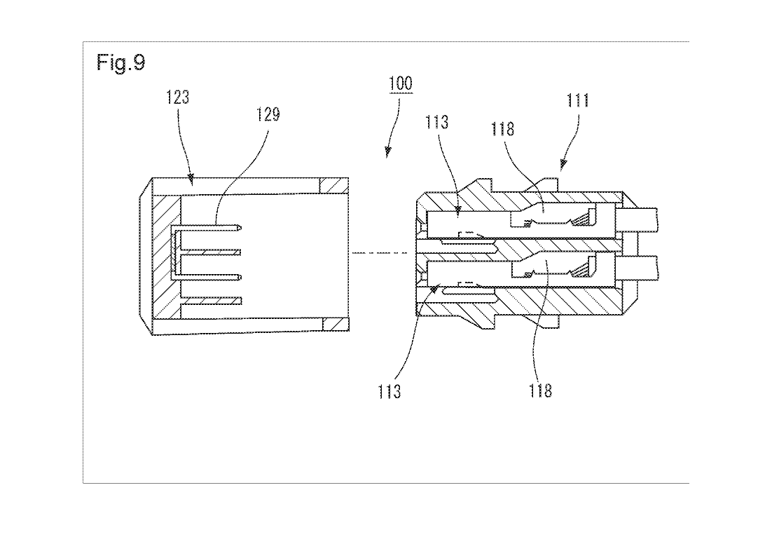

As shown in FIGS. 7 and 8, each of the tab observing windows 37 is formed at a position where the distal end of the tab piece 11 can be visually observed, and it is possible to visually observe a state where the electrical connecting part 21 is engaged with the tab piece 11.

As shown in FIGS. 4 and 7, each of the engaging grooves 40 is open directed to an end of the guide groove 35 at a side of the one end part 31 of the housing, and restrains the insertion guiding projection 24 of the electrical connecting part 21 which is engaged and connected with the tab piece 11 from moving in a direction perpendicular to the terminal inserting direction (a vertical direction in the drawings).

The engaging grooves 40 in this embodiment are defined by a plurality of comb-shaped projections 38 which are formed in one parts of the bottom walls of the terminal containing rooms 34 so as to extend toward the other end part 32 of the housing. Therefore, it is possible to easily form the engaging grooves 40 in the connector housing 30 by integral molding.

Further, a taper face 38a for guiding the insertion guiding projection 24 to be inserted into the engaging groove 40 is formed at a tip end of each of the comb-shaped projections 38. Therefore, it is possible to smoothly guide the insertion guiding projection 24 to be inserted into the engaging groove 40.

Then, referring to FIGS. 4 to 8, an operation when the female type terminal metal fittings 20 are inserted into the connector housing 30 of the joint connector 1 will be described.

As a first step, the joint terminal 10 is received and held in the one end part 31 of the connector housing 30, as shown in FIG. 4, and thereafter, the female type terminal metal fittings 20 are respectively inserted into the terminal containing rooms 34 from the other end part 32 of the connector housing 30.

The female type terminal metal fittings 20 are inserted into the terminal containing rooms 34, while the insertion guiding projections 24 are inserted and guided in the guide grooves 35. In each of the terminal containing rooms 34, when the terminal locking projection 36b of the locking lance 36 is pressed and urged against the bottom face of the electrical connecting part 21, the elastic arm 36a is elastically deformed outward so as not to disturb insertion of the female type terminal metal fitting 20.

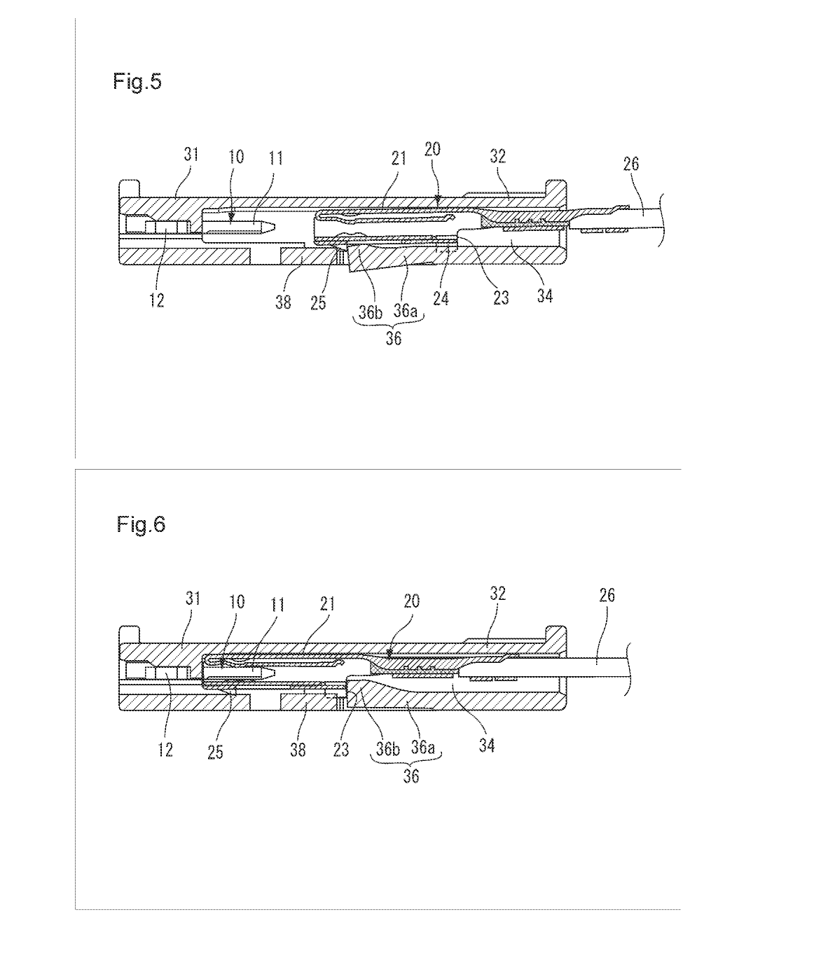

Then, as shown in FIG. 5, when the guide projection 25 which is provided at the distal end side of the electrical connecting part 21 comes into contact with the tip end of the comb-shaped projection 38, the distal end opening of the electrical connecting part 21 to be engaged with the tab piece 11 is guided upward toward the tab piece 11, by an action of the inclined face 25a of the guide projection 25. As the results, a thrust of the electrical connecting part 21 against the tab piece 11 is prevented, and the electrical connecting part 21 is smoothly engaged and connected with the tab piece 11.

Then, as shown in FIG. 7, when the female type terminal metal fitting 20 has been inserted up to a position just short of the prescribed position in the connector housing 30, the insertion guiding projection 24 is guided by the taper face 38a which is formed at the tip end of the comb-shaped projection 38 thereby to be inserted into the engaging groove 40.

Then, as shown in FIG. 6, when the female type terminal metal fitting 20 has been inserted up to the prescribed position in the terminal containing room 34 of the connector housing 30, the terminal locking projection 36b of the locking lance 36 which has been elastically restored with passage of the electrical connecting part 21 is locked to the retaining lock part 23 thereby to prevent drop of the female type terminal metal fitting 20.

Further, in a state where the female type terminal metal fitting 20 has been inserted up to the prescribed position in the terminal containing room 34, the insertion guiding projection 24 of the electrical connecting part 21 which is engaged and connected with the tab piece 11 of the joint terminal 10 is restrained from moving in a direction perpendicular to the terminal inserting direction (the vertical direction in the drawings), by the engaging groove 40 of the connector housing 30, as shown in FIG. 8. As the results, a backlash of the electrical connecting part 21 with respect to the tab piece 11 in the mutually engaged state can be eliminated, and contact stability between the female type terminal metal fitting 20 and the joint terminal 10 can be enhanced.

Specifically, besides the guide groove 35 for guiding the insertion guiding projection 24 of the female type terminal metal fitting 20 which has been inserted into the terminal containing room 34, the engaging groove 40 can eliminate a backlash of the electrical connecting part 21 in a state engaged and connected with the tab piece 11. As the results, the backlash of the electrical connecting part 21 will not be restrained more than required, before the distal end opening of the electrical connecting part 21 is engaged with the tab piece 11. In this manner, it is possible to depress a thrust of the female type terminal metal fitting 20 against the tab piece 11.

According to the joint connector 1 in the above described embodiment, the backlash of the electrical connecting part 21 with respect to the tab piece 11 in the engaged state can be eliminated, and the contact stability between the female type terminal metal fitting 20 and the joint terminal 10 can be enhanced.

Moreover, the backlash of the electrical connecting part 21 will not be restrained more than required, before the distal end opening of the electrical connecting part 21 is engaged with the tab piece 11. In this manner, it is possible to depress a thrust of the female type terminal metal fitting 20 against the tab piece 11.

It is to be noted that structures of the female type terminal metal fitting, joint terminal, connector housing, electrical connecting part, insertion guiding projection, terminal containing room, guide part, engaging groove, comb-shaped projection, and guide projection, etc. of the joint terminal according to the present invention are not limited to the structures in the above described embodiment. It is needless to say that various modes can be adopted on the basis of gist of the present invention.

According to the present invention, it is possible to provide the joint connector in which the contact stability between the female type terminal metal fittings and the joint terminal can be enhanced, and at the same time, thrusts of the female type terminal metal fittings against the joint terminal can be restrained.

What is claimed is:

1. A joint connector, comprising:
A plurality of female type terminal metal fittings;
a joint terminal including a plurality of tab pieces which are adapted to be engaged and connected with the female type terminal metal fittings, and a connecting part for interconnecting the tab pieces for electrical continuity; and
a connector housing formed of synthetic resin and including one end part of the housing which receives and holds the joint terminal having the tab pieces directed to the other end side of the housing, and the other end part of the housing provided with a plurality of terminal containing rooms in which electrical connecting parts of the female type terminal metal fittings and the tab pieces are brought into a mutually engaged state, by inserting the female type terminal metal fittings up to a prescribed position;
wherein the electrical connecting parts of the female type terminal metal fittings are respectively provided with insertion guiding projections to be guided by being inserted into guide parts formed on inner walls of the terminal containing rooms along a terminal inserting direction; and
the terminal containing rooms are provided, on their respective inner walls, with engaging grooves for restraining the insertion guiding projections of the electrical connecting parts which are engaged and connected with the tab pieces from moving in a direction perpendicular to the terminal inserting direction.

2. The joint connector as claimed in claim 1, wherein the engaging grooves are defined by a plurality of comb-shaped projections which are formed in one parts of bottom walls of the terminal containing rooms so as to extend toward the other end side of the housing.

3. The joint connector as claimed in claim 2, wherein taper faces for guiding the insertion guiding projections to be inserted into the engaging grooves are respectively formed at tip ends of the comb-shaped projections.

4. The joint connector as claimed in claim 1, wherein the electrical connecting parts of the female type terminal metal fittings are provided with guide projections respectively having inclined faces which are inclined for and downward with respect to surfaces of the terminals, at a position dose to a distal end side of the terminals than a position where the insertion guiding projections are provided, and
when the tip ends of the comb-shaped projections come into contact with the guide projections, distal end openings of the electrical connecting parts to be engaged and connected with the tab pieces are guided toward the tab pieces.
